(19) United States
(12) Patent Application Publication
(10) Pub. No.: US 2006/0081472 A1
(43) Pub. Date: Apr. 20, 2006

(54) Gas sensor

(76) Inventors: Hans-Martin Wiedenmann, Stuttgart (DE); Lothar Diehl, Gerlingen (DE); Thomas Moser, Schwieberdingen (DE); Stefan Rodewald, Ditzingen (DE)

Correspondence Address: KENYON & KENYON LLP, ONE BROADWAY, NEW YORK, NY, 10004, US

(21) Appl. No.: 11/250,266

(22) Filed: Oct. 13, 2005

(30) Foreign Application Priority Data
Oct. 13, 2004 (DE) 102004049874.1

(51) Int. Cl. G01N 27/26

(52) U.S. Cl. 204/424; 204/421; 204/431

(57) ABSTRACT

A gas sensor is used for detecting a physical property of a measuring gas, preferably for determining the oxygen concentration of an exhaust gas of an internal combustion engine. The gas sensor includes a layered sensor element which has a measuring gas space, in which an electrode on a solid electrolyte is situated. The sensor element includes a first diffusion barrier and a second diffusion barrier and a cavity, situated between the first and the second diffusion barriers, the measuring gas space being connected to the measuring gas outside the sensor element via the first diffusion barrier, the cavity, and the second diffusion barrier.

### BACKGROUND INFORMATION

A gas sensor, which is used for determining the oxygen concentration in a measuring gas, e.g., an exhaust gas of an internal combustion engine, is described in German Patent Application No. DE 101 54 869. The gas sensor is what is called a broadband lambda sensor, whose function is described in Automotive Electronics Handbook, Editor in Chief: Ronald K. Jurgen, Second Edition, 1999, McGraw-Hill, for example.

The gas sensor includes a planar, oblong, and layered sensor element which is mounted in a housing of the gas sensor in a gas-tight manner. The sensor element has a first and a second solid electrolyte foil, between which a measuring gas space and a diffusion barrier are situated. The measuring gas, situated outside the sensor element, may reach the measuring gas space through a gas inlet aperture made in the first solid electrolyte foil, and through the diffusion barrier. An electrode is situated in the measuring gas space and is connected to another electrode via the first solid electrolyte foil, the second electrode being situated on an outside surface of the sensor element, for example. By applying a pump voltage between the electrodes, oxygen is pumped from one electrode to the other electrode and thus, depending on the pumping direction, into or out of the measuring gas space in such a way that an oxygen partial pressure of lambda=1 prevails in the measuring gas space. If the measuring gas has an oxygen partial pressure greater or less than lambda=1, a gradient is formed in the diffusion barrier with respect to the oxygen partial pressure.

If the pressure of the measuring gas increases (at the same high oxygen concentration), then the pressure of the gas in the measuring gas space also increases. As the pressure increases, the gas situated inside the diffusion barrier is pressed into the measuring gas space. Prior to the pressure increase, the gas situated in the diffusion barrier has an oxygen partial pressure of approximately lambda=1 only on the side facing the measuring gas space. The oxygen partial pressure on the opposite side corresponds approximately to the (high) oxygen partial pressure of the measuring gas situated outside the sensor element. In the case of a measuring gas having a high oxygen concentration (i.e., lambda>1), the measuring gas, pressed from the diffusion barrier into the measuring gas space due to the pressure increase, has an oxygen partial pressure greater than lambda=1. This means that along with a sudden pressure increase in the measuring gas space, a sudden increase in the oxygen partial pressure occurs, without the oxygen concentration in the measuring gas outside the sensor element having actually increased.

Therefore, it is disadvantageous in such a sensor element that in the event of pressure pulses, i.e., sudden extreme pressure increases outside the sensor element, the measuring gas situated in the diffusion barrier is pressed into the measuring gas space, thereby impairing the measuring function of the sensor element.

### SUMMARY OF THE INVENTION

The gas sensor according to the present invention has the advantage over the related art in that the measuring function of the sensor element is only negligibly or not at all affected by pressure pulses.

For this purpose, the sensor element includes a first and a second diffusion barrier and a cavity is provided between the first and the second diffusion barrier. The measuring gas may reach the measuring gas space and the electrode situated in the measuring gas space via the second diffusion barrier (having a diffusion resistance D₂), the cavity, and the first diffusion barrier (having a diffusion resistance D₁). Measuring gas in equilibrium having a mean oxygen partial pressure, which is determined in the steady state by the quotient D₂/D₁, is situated in the cavity. In the event of a pressure pulse in the measuring gas situated outside the sensor element, the measuring gas is pressed from the second diffusion barrier into the cavity, causing the pressure in the cavity to rise. This continues via the first diffusion barrier up to the measuring gas space.

Measuring gas is primarily pressed from the cavity into the measuring gas space, thereby preventing measuring gas from the second diffusion barrier having a decidedly higher oxygen partial pressure from reaching the measuring gas space. In addition, the cavity is used as a storage volume via which the propagation of the pressure wave toward the measuring gas space is delayed. If the pressure pulse is followed by a pressure reduction in the exhaust gas, then a pressure pulse may at least largely be counterbalanced by a subsequent pressure reduction due to the buffer function of the cavity.

The first diffusion barrier is preferably annular and is surrounded by the annular measuring gas space, the second diffusion barrier being situated inside the first diffusion barrier, and the annular cavity being provided between the first and the second diffusion barrier. The measuring gas space, the first diffusion barrier, the cavity, and the second diffusion barrier are situated between a first and a second solid electrolyte layer. The exhaust gas reaches the second diffusion barrier, for example, via a gas inlet aperture which is made in the first solid electrolyte layer. Due to the cylindrical arrangement, the diffusion cross-section surface increases for the measuring gas diffusing toward the measuring gas space. Therefore, the storage volume from the second diffusion barrier to the measuring gas space, available for pressure pulses, also increases. Pressure pulses, which propagate starting from the measuring gas situated outside the sensor element via the gas inlet aperture, the second diffusion barrier, the cavity, and the first diffusion barrier up to the measuring gas space, are additionally weakened by the cylinder geometry.

The propagation of pressure pulses is reduced particularly effectively when the outside diameter of the second diffusion barrier is in the range of 0.5 mm to 1.5 mm, in particular around 1.0 mm, when the inside diameter of the first diffusion barrier is in the range of 0.7 mm to 2.0 mm, in particular around 1.5 mm, and/or when the outside diameter of the first diffusion barrier is in the range of 1.5 mm to 3.0 mm, in particular around 2.3 mm. The second diffusion barrier may be cylindrical or may have a central recess having an inside diameter in the range of 0.25 mm to 0.7 mm, in particular around 0.5 mm.

If the pores or the layer thickness of the first and/or the second diffusion barrier are smaller than the average free path length of gas molecules between two pulses, then impacts against the wall prevail, thereby changing the diffusion mechanism from gas phase diffusion to Knudsen diffusion. Since only impacts between particles effect a pulse transfer, only they are effective for the propagation of the pressure pulse. Therefore, the change to Knudsen diffusion increases the flow resistance and lowers the effectiveness of pressure pulses. The average pore diameter of a porous diffusion barrier is preferably 5 μm at the most, in particular 3 μm at the most. The preferred layer thickness of such a porous diffusion barrier is 15 μm at the least, in particular 25 μm at the least. The first and/or the second diffusion barrier may alternatively also be implemented by a cavity (i.e., without a porous filling) having a low height, the height of the diffusion barrier, designed as a cavity, being 10 μm at the most, in particular 5 μm at the most.

Since the cavity reduces the propagation of pressure pulses and since the pressure pulses still exist in the cavity itself, the electrodes which indirectly or directly generate the measuring signal of the sensor element are not to be placed in the cavity, but rather downstream from the cavity, i.e., in the measuring gas space. To that effect, no electrode containing a catalytically active material is provided in the cavity.

In the sense of this application, a cavity is also to be understood as a space filled with a porous material, as long as the gas circulation or the gas diffusion inside this space is not substantially obstructed by the porous material, in particular decidedly less than inside the diffusion barrier. A decidedly lower gas circulation occurs, for example, when the quantity of pores in the porous material situated in the cavity is at least three times as large as that of the porous material of the diffusion barrier.

### BRIEF DESCRIPTION OF THE DRAWINGS

FIG. 1 shows a longitudinal section of a sensor element along line I-I in FIG. 2 as a first exemplary embodiment of the present invention.

FIG. 2 shows a section of the sensor element according to the present invention along line II-II in FIG. 1.

FIG. 3 shows a detail of a second exemplary embodiment of the present invention.

### DETAILED DESCRIPTION

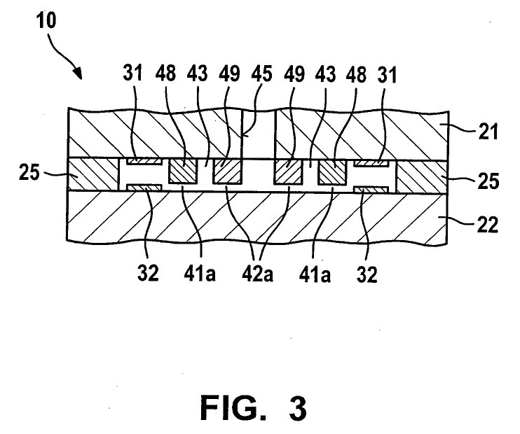

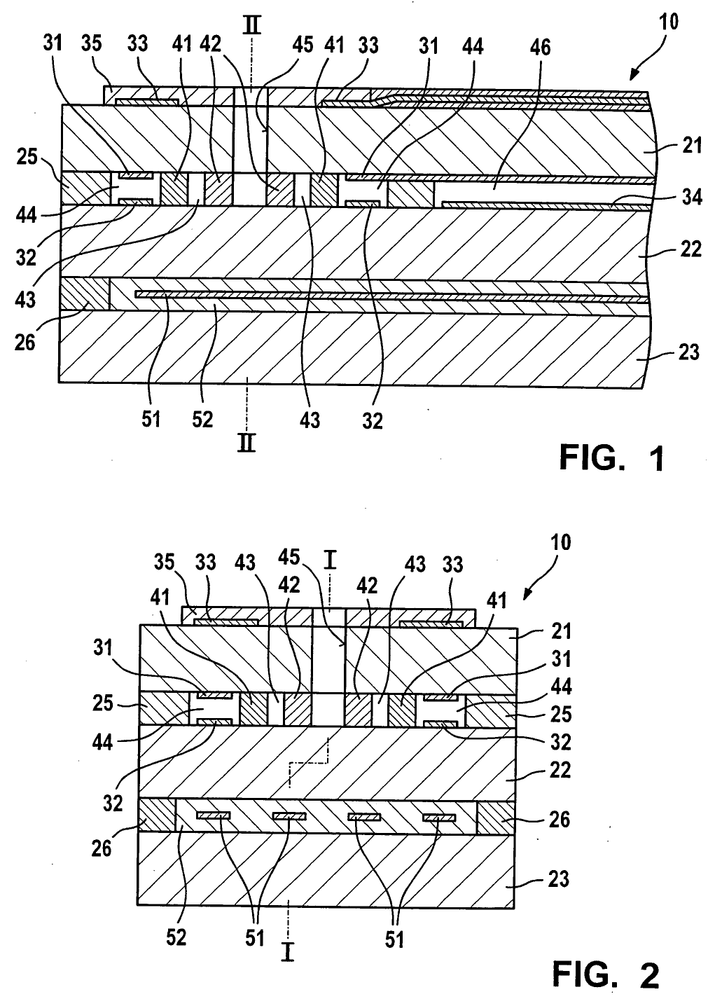

As an exemplary embodiment of the present invention, FIGS. 1 and 2 show a planar, layered sensor element 10 which is situated in a housing in a gas-tight manner via a sealing system and which is used to detect the oxygen partial pressure in an exhaust gas of an internal combustion engine. FIG. 1 shows the section of sensor element 10 on the measuring side containing the measuring elements. The section of sensor element 10 on the connection side (not shown) contains the lead area and the contacting area. The configuration of the sensor element and the installation of the sensor element in the housing of the gas sensor is described in Automotive Electronics Handbook, editor in chief: Ronald K. Jurgen, second edition, 1999, McGraw-Hill, for example.

Sensor element 10 has a first, a second, and a third solid electrolyte layer 21, 22, 23. Sensor element 10 has an annular (hollow-cylindrical) measuring gas space 44 between first and second solid electrolyte layer 21, 22. A first annular (hollow-cylindrical) diffusion barrier 41 is situated in the center of measuring gas space 44; a second diffusion barrier 42 is in turn situated in the center of first diffusion barrier 41. Both diffusion barriers 41, 42 are separated by a cavity 43. First solid electrolyte layer 21 has a gas inlet aperture 45 which opens into the center of second diffusion barrier 42. The exhaust gas situated outside sensor element 10 may reach measuring gas space 44 via gas inlet aperture 45, second diffusion barrier 42, cavity 43 and first diffusion barrier 41. Measuring gas space 44 is laterally surrounded and sealed by a sealing frame 25.

A reference gas space 46, separated from measuring gas space 44 in a gas-tight manner, is provided between first and second solid electrolyte layers 21, 22, the reference gas space extending in the direction of the longitudinal axis of sensor element 10. As a reference gas, reference gas space 46 contains a gas having a high oxygen concentration, e.g., ambient air.

A heating element 51 is provided between second and third solid electrolyte layers 22, 23, the heating element including a heater printed conductor which is separated from surrounding solid electrolyte layers 22, 23 by a heater insulation 52. Heating element 51 is laterally surrounded by a heater frame which seals heating element 51 in a gas-tight manner.

In measuring gas space 44, an annular first electrode 31 is applied to first solid electrolyte layer 21 and, opposite first electrode 31, an annular second electrode 32 is applied to second solid electrolyte layer 22. An annular third electrode 33, with gas inlet aperture 45 situated in its center, is provided on the outer surface of first solid electrolyte layer 21. Third electrode 33 is covered by a porous protective layer 35. A fourth electrode 34 is provided in reference gas space 46.

First and third electrodes 31, 33 and solid electrolyte 21, situated between first and third electrodes 31, 33, form an electrochemical cell which is operated as a pump cell via a circuit situated outside sensor element 10. Second and fourth electrodes 32, 34 and solid electrolyte 22, situated between second and fourth electrodes 32, 34, form another electrochemical cell which is operated as a Nernst cell. The Nernst cell measures the oxygen partial pressure in measuring gas space 44. The pump cell pumps oxygen into or out of measuring gas space 44 in such a way that an oxygen partial pressure of lambda=1 prevails in measuring gas space 44. Such sensor elements are known to those skilled in the art as broadband lambda sensors.

Second diffusion barrier 42 has an inner diameter of 0.5 mm and an outer diameter of 1.0 mm. First diffusion barrier 41 has an inner diameter of 1.5 mm and an outer diameter of 2.3 mm. Since cavity 43 is directly adjacent to first and second diffusion barriers 41, 42, the outer diameter of second diffusion barrier 42 corresponds to the inner diameter of cavity 43 and the inner diameter of first diffusion barrier 41 corresponds to the outer diameter of cavity 43. Moreover, the outer diameter of first diffusion barrier 41 corresponds to the inner diameter of measuring gas space 44.

The layer thickness of measuring gas space 44, first and second diffusion barriers 41, 42, and cavity 43, i.e., the distance of the first from the second solid electrolyte layer, is approximately 30 μm.

In an alternative embodiment (not shown), second diffusion barrier 42 has a cylindrical shape, gas inlet aperture 45 to second diffusion barrier 42 being situated in the center and ending in the layer plane between first solid electrolyte layer 21 and second diffusion barrier 42.

The detail of a second exemplary embodiment of the present invention shown in FIG. 3 corresponds to the cross section of sensor element 10 shown in FIG. 2 and differs from the first exemplary embodiment merely by the fact that first and second diffusion barriers 41a, 42a are designed as a cavity having a low height (i.e., a small extension in the direction perpendicular to the major surface of sensor element 10). First and second diffusion barriers 41a, 42a, which are situated between second solid electrolyte layer 22 and a constriction element 48, 49 applied to first solid electrolyte layer 21, have a height of 2.5 μm. Of course, constriction elements 48, 49 may also be applied (separately or together) to second solid electrolyte layer 22.

Of course, the present invention may also be applied to more than two diffusion barriers which are situated successively and separated by a cavity.

What is claimed is:

1. A gas sensor for detecting a physical property of a measuring gas, comprising:
a layered sensor element which has a measuring gas space; and
an electrode on a solid electrolyte being situated in the measuring gas space,
wherein the sensor element includes a first diffusion barrier and a second diffusion barrier and a cavity situated between the first and the second diffusion barriers, so that the measuring gas space is connected to the measuring gas outside the sensor element via the first diffusion barrier, the cavity, and the second diffusion barrier.

2. The gas sensor according to claim 1, wherein the first diffusion barrier has an annular shape and the second diffusion barrier is situated inside the first diffusion barrier.

3. The gas sensor according to claim 1, wherein the second diffusion barrier has a cylindrical outer lateral surface which borders on the cavity.

4. The gas sensor according to claim 1, wherein the first diffusion barrier is hollow-cylindrical and has an inner and an outer lateral surface, the inner lateral surface of the first diffusion barrier bordering on the cavity and the outer lateral surface of the first diffusion barrier bordering on the measuring gas space.

5. The gas sensor according to claim 1, further comprising first and second solid electrolyte layers, and wherein the first diffusion barrier, the cavity, and the second diffusion barrier are situated in a layer plane between the first solid electrolyte layer and the second solid electrolyte layer.

6. The gas sensor according to claim 2, wherein an inner diameter of the second diffusion barrier is in a range of 0.25 mm to 0.7 mm, an outer diameter of the second diffusion barrier is in a range of 0.5 mm to 1.5 mm, an inner diameter of the first diffusion barrier is in a range of 0.7 mm to 2.0 mm, and an outer diameter of the first diffusion barrier is in a range of 1.5 mm to 3.0 mm.

7. The gas sensor according to claim 6, wherein:
the inner diameter of the second diffusion barrier is about 0.5 mm,
the outer diameter of the second diffusion barrier is about 1.0 mm,
the inner diameter of the first diffusion barrier is about 1.5 mm, and
the outer diameter of the first diffusion barrier is about 2.3 mm.

8. The gas sensor according to claim 1, wherein at least one of the first diffusion barrier and the second diffusion barrier has a porous material.

9. The gas sensor according to claim 8, wherein the porous material of at least one of the first diffusion barrier and the second diffusion barrier has an average pore diameter of 5 μm at the most.

10. The gas sensor according to claim 9, wherein the average pore diameter is 3 μm at the most.

11. The gas sensor according to claim 6, wherein a layer thickness of at least one of the first diffusion barrier, the second diffusion barrier, the cavity and the measuring gas space is at least 15 μm.

12. The gas sensor according to claim 11, wherein the layer thickness is at least 25 μm.

13. The gas sensor according to claim 1, wherein at least one of the first diffusion barrier and the second diffusion barrier is a cavity having a height of 10 μm at the most.

14. The gas sensor according to claim 13, wherein the height is 5 μm at the most.

15. The gas sensor according to claim 5, wherein a gas inlet aperture is situated in the first solid electrolyte layer in such a way that exhaust gas can reach the second diffusion barrier via the gas inlet aperture.

16. The gas sensor according to claim 1, wherein a material bordering on the cavity is catalytically inactive.

17. The gas sensor according to claim 1, wherein no electrode is situated in the cavity.

18. The gas sensor according to claim 1, wherein the gas sensor is for determining an oxygen concentration of an exhaust gas of an internal combustion engine.
